(19) United States
(12) Patent Application Publication
(10) Pub. No.: US 2003/0212804 A1
(43) Pub. Date: Nov. 13, 2003

(54) Method and apparatus for media clip sharing over a network

(76) Inventor: Ardeshir Hashemi, Federal Way, WA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/143,695

(22) Filed: May 9, 2002

(51) Int. Cl. G06F 15/173

(52) U.S. Cl. 709/228; 709/231; 709/238

(57) ABSTRACT

The invention relates to the sharing of media clips, such as sound and video, among various computer systems without the sharing of the corresponding media clip files. A media clip may be shared by streaming the media clip within a peer-to-peer group. The users within the peer-to-peer group can be selected to provide a relative amount of privacy and security. A user can select media clip that is streamed remotely such that the user may have control over the content of the streamed media clip.

### BACKGROUND OF THE INVENTION

1. Field of the Invention

The invention generally relates to computer networking. In particular, the invention may relate to the sharing of media clips over an electronic network.

2. Description of the Related Art

Consumers enjoy listening to or watching various forms of media clips including audio works, such as music, and video works, such as movies and home videos. Consumers enjoy these forms of media in a variety of locations, including at home, at work, and while on travel.

Various broadcast techniques, such as radio and television broadcasts, exist to allow a user to receive a media clip. Although a consumer can select between a number of broadcasts, the consumer generally does not have control of the content that is broadcast. Consumers often desire control over such content such as the selection of a particular piece of music or the selection of a particular video such as a home video from a particular date. However, it is often not practical for a consumer to carry an entire library of work while traveling or to maintain duplicate copies of a work in disparate locations.

A number of audio/video services or tools exist, such as Napster, Aimster, Morpheus, KaZaA Media Desktop, Winmx, Gnutella, Scour, Bearshare, Limeware, OpenNap, Espra, BitBop Tuner, and the like. Disadvantageously, some of the file-sharing services such as Napster allow a user to download an entire file. Although the downloading of a file has certain advantages, the transfer of the file and subsequent viewing and/or listening can be undesirable from the perspective of a content owner or licensee. The relative ease with which a copy of a file can be obtained can lead to undesired further duplication and distribution. Further, the transfer of files can be in non-real time, which permits a user to transfer a substantial quantity of data from another user in a relatively short period of time. This can undesirably occupy a relatively large amount of the network bandwidth for both the user who is copying the file and a user who is providing the file.

In addition, it may be undesirable for a consumer to make an entire library of work publicly accessible to anyone. For example, the user may have home recordings of music or videos that the user prefers to keep relatively private. Also, a user may not wish to have access to a large database of media as searching for desired content can be cumbersome and an inefficient use of time and resources.

What is needed are techniques that allow users to share media content or to access such media content remotely in an efficient, relatively secure, and relatively private manner.

### BRIEF DESCRIPTION OF THE DRAWINGS

These and other features of the invention will now be described with reference to the drawings summarized below. These drawings and the associated description are provided to illustrate preferred embodiments of the invention and are not intended to limit the scope of the invention.

FIG. 1A illustrates a networked system, including Web components, for implementing a media clip sharing system in accordance with one embodiment of the invention.

FIG. 1B illustrates a high-level block diagram of one embodiment of a user computer.

FIG. 1C illustrates a high-level block diagram of one embodiment of a user computer.

FIG. 2 illustrates a sample user interface.

FIG. 3 illustrates a process according to an embodiment of the invention of streaming a media clip.

FIG. 4 illustrates a process according to an embodiment of the invention of selecting multiple media clips from multiple peer computers for streaming.

FIG. 5 illustrates a process according to an embodiment of the invention of streaming multiple media clips from multiple peer computers.

FIG. 6A illustrates a data structure that can be used by a system to store or to maintain an arrangement of media clips.

FIG. 6B illustrates the data structure of FIG. 6A with sample data.

### DETAILED DESCRIPTION OF PREFERRED EMBODIMENTS

Although this invention will be described in terms of certain preferred embodiments, other embodiments that are apparent to those of ordinary skill in the art, including embodiments that do not provide all of the benefits and features set forth herein, are also within the scope of this invention. Accordingly, the scope of the invention is defined only by reference to the appended claims.

I. Media Clip Sharing System

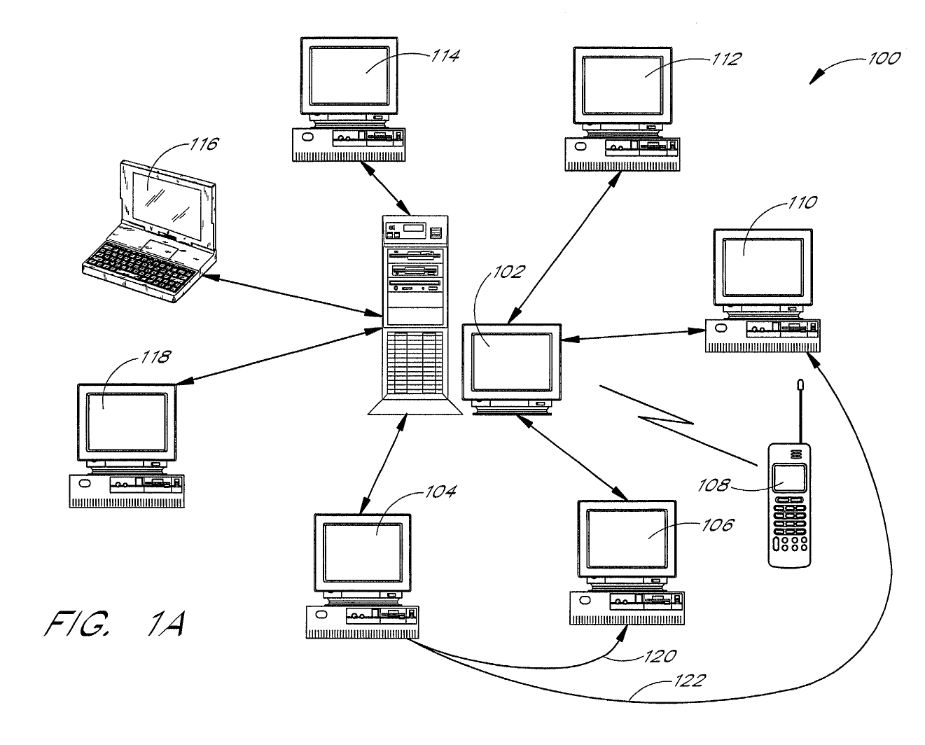

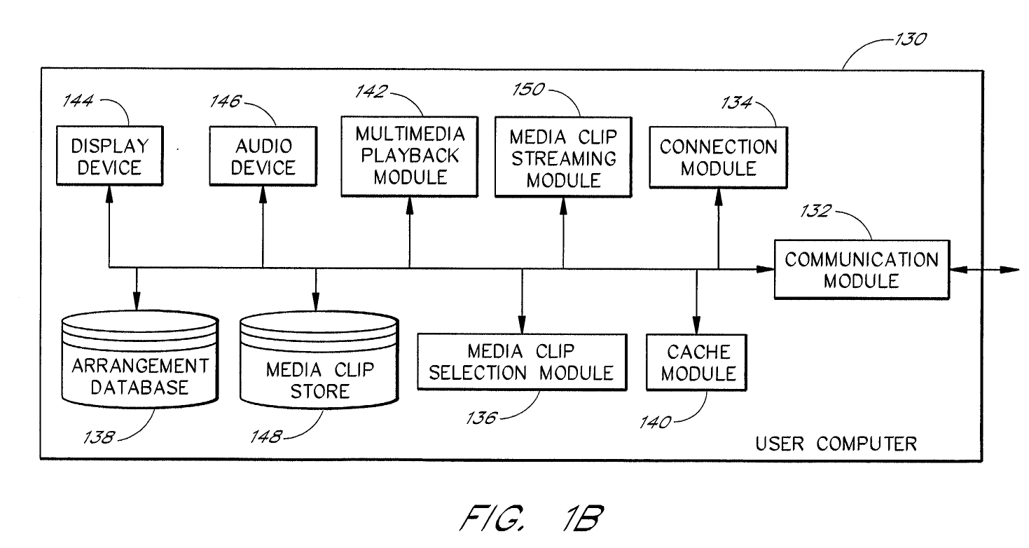

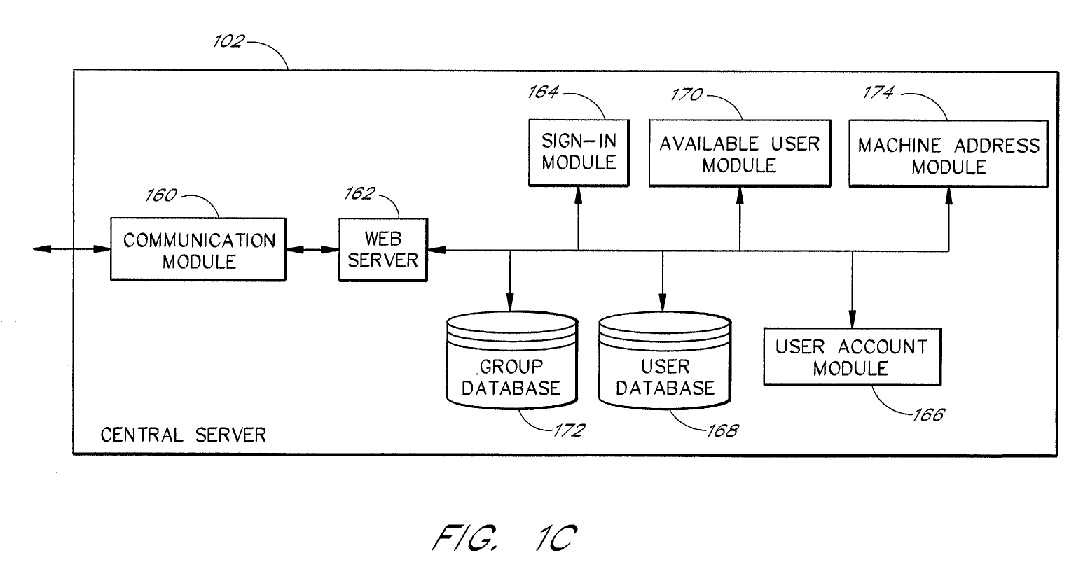

FIG. 1A illustrates one embodiment of the invention of a networked system 100 including a media clip sharing system. A network of computers includes at least two computer systems that are linked together. A media clip includes at least a portion of an audio work or a video work, which has been recorded or stored. The illustrated media clip sharing system includes a central server 102, which may be coupled with multiple user computers or nodes. A node corresponds to a processing location in a network. A node may be, for example, a computer system. It will be understood by one of ordinary skill in the art that the central server 102 can correspond to multiple servers in remote locations, as well as to a single computer in one location. In one embodiment, the media clip sharing system may advantageously be implemented as a computer program and executes on multiple computers. One embodiment includes a software program that is embodied in a tangible medium. However, it will be understood by one of ordinary skill in the art that portions of the media clip sharing system can be implemented by dedicated hardware or by a combination of both dedicated hardware and software.

A. User Computer

To illustrate the operation of the media clip sharing system, the networked system 100 may advantageously be shown with a first user computer 104, a second user computer 106, a third user computer 108, a fourth user computer 110, a fifth user computer 112, a sixth user computer 114, a seventh user computer 116, and an eighth user computer 118. Of course, the number of computers in the networked system 100 can vary in a broad range and can change over time as computers connect and disconnect from networks and may advantageously be powered on and off.

FIG. 1B illustrates one embodiment of a user computer 130 that can be used with the networked system 100 described earlier in connection with FIG. 1A. The exemplary user computer 130 may advantageously be configured to both send and receive streams of media clips. A stream can correspond to a data transfer technique that advantageously permits data to be used, e.g., displayed or played, before all of the data is received. However, it will be understood by one of ordinary skill in the art that a user computer can also be configured to only send or to only receive a stream of a media clip.

The exemplary user computer 130 includes a communication module 132 that may advantageously be adapted to permit the exemplary user computer 130 to communicate with other computers, such as the central server 102 or another user computer. A connection module 134 permits the exemplary user computer 130 to connect to the central server 102 and/or to another user computer. The connection module 134 configures the exemplary user computer 130 to communicate with the other computers or devices thereby establishing a connection. A connection or communication between computers can be established with a connection-oriented protocol, a connectionless oriented protocol, or both. It will be understood that a connection between computers can be established without the addition of additional physical wiring or switching. A media clip selection module 136 permits a user to select which media clips from a list of media clips may be received in a stream from another user computer. A user can be an individual or an entity that uses a computer system. A selection of media clips can also be stored in an arrangement database 138 for convenient retrieval of arrangements of multiple media clips.

A cache module 140 temporarily stores data received in a stream by the communication module 132 so that the data may advantageously be available for access by a multimedia playback module 142. The multimedia playback module 142 configures the streamed media clip such that the streamed media clip can be played back on a display device 144 and/or an audio device 146.

The exemplary user computer 130 can also send a stream of a media clip to another user computer. A media clip store 148 stores the media clip. The media clip store 148 can correspond to a variety of data stores, including a hard disk, an optical disk, a random access memory device, and the like. A data store or memory can correspond to a device that permits a computer system to store and retrieve information, such as data and/or programs. A data store can include physical memory, such as random access memory (RAM), whether volatile or nonvolatile, and can include mass memory, such as hard disks. A media clip streaming module 150 retrieves the media clip from the media clip store 148 and provides the media clip to another user computer via the communication module 132.

A user computer from the multiple user computers can be any microprocessor or processor controlled device, including, but not limited to a terminal device, such as a personal computer, a workstation, a server, a client, a mini computer, a main-frame computer, a laptop computer, a network of individual computers, a mobile computer, a palm top computer, a hand held computer, a set-top box for a TV, an interactive television, an interactive kiosk, a personal digital assistant, an interactive wireless communications device, a wireless Web-enabled cell phone, and the like. Where a user computer both receives streams of media clips and sources streams of media clips, the user computer can behave as both a client and a server. A user computer can also include a server such as the RealServer™ from RealNetworks, Inc of Seattle, Wash. or a scaled-down version of the RealServer™.

These user computers described may be uniprocessor or multiprocessor machines. Additionally, these computers include an addressable storage medium or computer accessible medium, such as random access memory (RAM), an electronically erasable programmable read-only memory (EEPROM), hard disks, floppy disks, laser disk players, digital video devices, Compact Disc ROMS, DVD-ROMS, video tapes, audio tapes, magnetic recording tracks, electronic networks, and other techniques to transmit or store electronic content such as, by way of example, programs and data. The computers may execute an operating system such as Linux, Unix®, Microsoft® Windows® 3.1, Microsoft® Windows® 9x, Microsoft® Windows® NT, Microsoft® Windows® 2000, Microsoft® Windows® Me, Microsoft® Windows® XP, Apple® MacOS®, IBM® OS/2®, Microsoft® Windows® CE, Palm OS®, Solaris™ operating environment software, and the like. The operating system can include a communications protocol implementation, which handles all incoming and outgoing message traffic passed over the network. In other embodiments, while the operating system may differ depending on the type of computer, the operating system may continue to provide the appropriate communications protocols necessary to establish communication links with the network.

The computers typically include program logic, or some other substrate configuration representing data and instructions, which causes a computer to operate in a specific and predefined manner as described herein. In one embodiment, the program logic can be implemented as one or more modules. The modules can be configured to reside on the addressable storage medium and configured to execute on one or more processors. A module can include part of a software program that may be combined or used together with other modules of the software program. A module can include data, can contain an executable function, or both. A module does not have to be located in the same file as another module with which it is combined. For example, a module can be located in a dynamic linked library (DLL). The modules may include, but may not be limited to, software or hardware components, which perform certain tasks. Thus, a module may include, by way of example, components, such as, software components, object-oriented software components, class components and task components, processes, methods, functions, attributes, procedures, subroutines, segments of program code, drivers, firmware, microcode, circuitry, data, databases, data structures, tables, arrays, and variables.

The depicted components can communicate with each other and other components comprising the respective computers through mechanisms such as, by way of example, interprocess communication, remote procedure call, and other various program interfaces. Furthermore, the functionality provided for in the components, modules, and databases may be combined into fewer components, modules, or databases or further separated into additional components, modules, or databases. Additionally, the components, modules, and databases can be implemented to execute on one or more computers.

The user computer may further possess input devices such as a keyboard, a mouse, a trackball, a touch pad, or a touch screen and output devices such as a computer screen, printer, speaker, or other input/output devices now in existence or later developed. It will be understood by one of ordinary skill in the art that a user or a person can own, operate, or control more than one user computer, and that one user computer can be operated by more than one user. A user computer within the networked system 100 can be identified by a user through a sign-in or login process, by user computer, or by a combination of both. A sign-in process can permit a computer system, server, network, and the like, to recognize a user to provide access to computer resources or selected features. The sign-in process can be completed by provision of a username and a password. Other terms that may be used to describe a sign-in process include “log on,” “login,” and “log in.” The term “user computer” shall be construed to include all such computer types, whether identified by user, user computer, or by a combination of both. For example, where a particular user logs into a user computer, that user computer can be associated with the user.

B. Central Server

In one embodiment, the central server 102 may advantageously be configured as a Web site for access by a user computer through a standard browser such as Netscape Navigator® developed by Netscape Communications Corporation of Mountain View, Calif. and Microsoft® Internet Explorer developed by Microsoft Corporation of Redmond, Wash. In another embodiment, the central server 102 communicates with a user computer through a customized interface. It should be understood that the term “site” may not be intended to imply a single geographic location, as a Web site or other network site can, for example, include multiple geographically distributed computer systems that may advantageously be appropriately linked together.

FIG. 1C illustrates one embodiment of the central server 102 that can be used with the networked system 100 described earlier in connection with FIG. 1A. The central server 102 includes a communication module 160, which may advantageously be configured to permit a Web server 162 to communicate with other networked computers including as user computers. The Web server 162 can, for example, provide a user computer with a Web page that shows the availability of other users and/or user computers in the media clip sharing system.

The exemplary central server 102 further includes a sign-in module 164 that permits a user to sign-in or login to the central server 102. The sign-in module 164 can associate a user and/or user computer to a user account, which may advantageously be accessed through a user account module 166 and a user database 168. The user account module 166 and the user database 168 can, for example, limit access to users who may be paying a monthly fee for access. When a user signs into the central server 102, an available user module 170 can relate the user to associated users in a group database 172 such that users in a peer group can ascertain the availability of other user computers for media clip sharing.

In one embodiment, a machine address module 174 relates a user name or a user computer name to a machine address, such as an IP address. A machine address corresponds to an identifier for a computer system or device on a network. The machine address can correspond to an IP address, which identifies a computer or device in a TCP/IP network. The user database 168 can maintain a cross reference of a user or user computer and a corresponding machine addresses. In one embodiment, the user database 168 may advantageously be updated when a user signs in such that a machine address that can dynamically change may advantageously be current.

C. Communication Among the User Computers and the Central Server

The user computers can communicate with each other and the central server 102 in a variety of mediums. In one embodiment, the user computers communicate with the central server 102 in a network with a client/server architecture. A client can correspond to a computer system on which a user can run an application. A client may receive resources, such as a file, from a server. A server can correspond to a computer system that may provide a resource, such as data or a file, to a client. In one embodiment, when a user computer communicates with the central server 102 or with another user computer to transmit and/or receive data other than a media clip, the user computer uses standard connection-oriented protocols such as HTTP and Transmission Control Protocol/Internet Protocol (TCP/IP). In one embodiment, when a user computer communicates with another user computer to send a stream of a media clip, the communication may advantageously be carried through a peer-to-peer network in accordance with a connectionless protocol such as the User Datagram Protocol (UDP) and Internet Packet Exchange (IPX), which allow greater throughput than connection-oriented protocols. A network with a peer-to-peer architecture can correspond to a network of at least two computer systems in which each computer system can serve or receive a resource. In one embodiment, a user computer may advantageously be adapted to send a stream of a media clip in accordance with RealTime Streaming Protocol (RTSP). Streaming of a media clip advantageously permits the computer receiving the stream to play or display the media clip while the media clip transfers and before an entire file has been transferred.

A user computer from the multiple user computers, such as the first user computer 104, communicates with the central server 102 to inform the central server 102 that the user computer may advantageously be available for sending and/or retrieving data and to retrieve information related to the availability of other user computers. For example, the first user computer 104 can be associated with a group of other users or user computers through a peer list. A familiar example of a peer list may advantageously be known as BUDDY LIST® from America Online, Inc (AOL). A peer list can be used to restrict access to send a stream of a media clip to those users or user computers within the corresponding peer list. This provides a user with more security and more privacy than where the media clip may advantageously be available to the public at large.

In one embodiment, the first user computer 104 retrieves a status from the central server 102. The status indicates which of the user computers in the peer list corresponding to the first user computer 104 may be available, signed in, or logged into the networked system 100.

The user computers can vary broadly in configuration and in coupling techniques to the central server 102. A user computer can be coupled with the central server 102 or to another user computer via a direct connection or via a network. The network can include a wide area network (WAN) such as the Internet, a local area network (LAN) such as an Ethernet, or both. The user computers can be equipped with communication devices such as a network interface card, a T-1 modem, a digital subscriber line (DSL) modem, a cable modem, an integrated services digital network (ISDN) modem, a dial-up modem, a wireless connection, and any other device suitable for communication over a network. It will be recognized that a network carrying a streamed media clip can also carry other types of information, such as data for word processing applications.

D. Peer Group

In one example, the first user computer 104, the second user computer 106, and the fourth user computer 110 form a group of peer computers, i.e., “peer group,” within the networked system 100. Each of the first user computer 104, the second user computer 106, and the fourth user computer 110 signs into the central server 102 and determines that the other user computers within the peer group may also be signed in. The central server 102 provides the user computers within the peer group with information that permits the user computers within the peer group to transfer data within the peer group in accordance with a peer-to-peer network as illustrated by a first peer-to-peer path 120 and a second peer-to-peer path 122. In one embodiment, the central server 102 detects a machine address such as an Internet Protocol (IP) address of a user computer upon the user computer's sign-in process and distributes the machine address to the other user computers within the peer group so that the user computers can form a peer-to-peer network. In another embodiment, the central server 102 distributes the user computer's machine address to a peer computer in the group of other user computers and permits the peer computer to form the peer-to-peer network.

II. User Interface

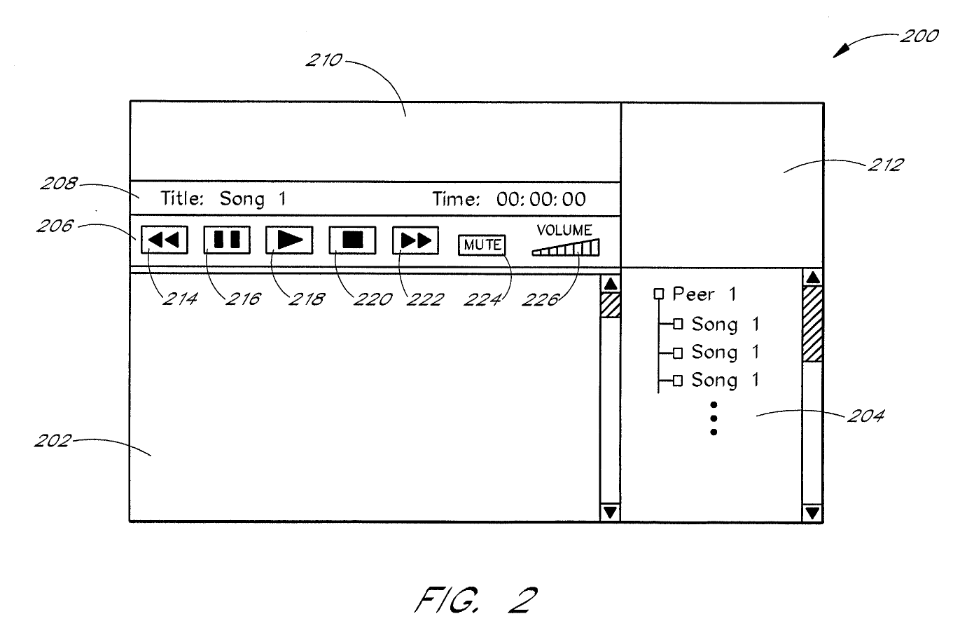

FIG. 2 illustrates a sample user interface 200 that can be displayed on a cathode ray tube (CRT), liquid crystal display (LCD), and the like. The sample user interface 200 includes a general access window 202, a media clip browse window 204, a control button bar 206, and a status bar 208. In one embodiment, the sample user interface 200 may advantageously be implemented in a customized interface with a separate window. In another embodiment, the sample user interface 200 may advantageously be implemented as a plug-in to a browser.

The exemplary general access window 202 may advantageously be used as a chat window, as a browser window, as a display of a user's locally stored media clips, and the like. The exemplary media clip browse window 204 displays a list of peers that may advantageously be signed in or logged onto the central server 102 and displays the media clips from the peers that may advantageously be available for streaming. In one embodiment, a user further selects which media clips in a related user computer should be made freely available for streaming within the peer group and which media clips require further authorization for streaming such as via a prompt in a pop-up window. One embodiment permits the users within a peer group to simultaneously chat while a media clip may advantageously be streamed from one user in the peer group to other users in the peer group, thereby allowing users to comment on particular sections of music, scenes of movies or other videos, and the like.

The exemplary media clip browse window 204 also indicates which media clips from the peer group may advantageously be available to be streamed. In other embodiments, the media clip browse window 204 also displays media clips that may advantageously be stored in the user's local computer. The control button bar 206 permits a user to control the playback of a streamed or streaming media clip. The controlling of streaming can include at least one of the initiation, termination, pausing, skipping, rewinding, reversing, fast forwarding, and the like, of streaming. Controlling can also include selection of content which may be streamed. The illustrated control button bar 206 includes a previous track/rewind button 214, a pause button 216, a play button 218, a stop button 220, a next track/fast forward button 222, a mute button 224, and a volume control 226. The exemplary status bar 208 displays information about the media clip that may advantageously be currently streamed, such as a title of a media clip, a duration of the media clip, and so forth.

The sample user interface 200 further includes an auxiliary window 210 and a display window 212. The exemplary auxiliary window 210 displays the program name, advertisements, and the like. The exemplary display window 212 displays logos, streamed video, advertisements, announcements, and the like.

III. Streaming a Media Clip

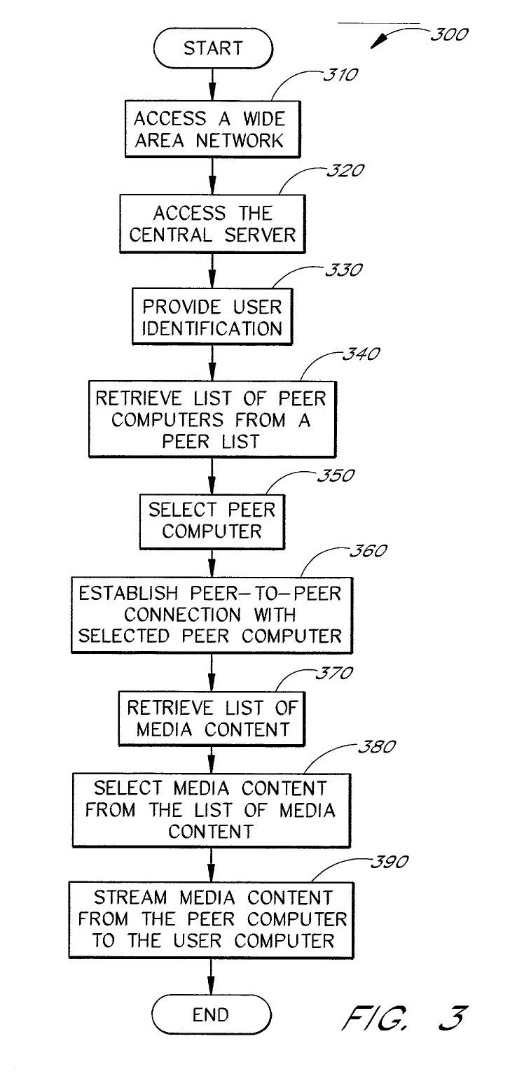

FIG. 3 illustrates a process 300, according to an embodiment of the invention, of streaming a media clip. The process can be implemented by customized software, by a plug-in to a browser, and the like. The process starts at a first block 310. In the first block, a user computer accesses a wide area network (WAN) such as the Internet. Typically, a user of the Internet via an Internet Service Provider (ISP) to which the user has previously subscribed. In exchange for a monthly fee, an ISP provides access to the Internet. The access can be via many mediums including modems on phone lines, satellite communications, cable modems, DSL, etc. The process advances from the first block 310 to a second block 320.

In the second block 320, the user computer accesses the central server 102 or a central node. In one embodiment, the user accesses the central server 102 in the second block 320 through a Web browser. In another embodiment, customized software interfaces with the central server 102. The central server 102 maintains lists of users that may advantageously be signed in or logged into the central server 102. The process advances from the second block 320 to a third block 330.

In the third block 330, a user provides a user identification to the central server 102. The user identification may be submitted by the user through a login or a sign-in process; however, the user identification may be submitted automatically through use of a machine address such as an IP address, or through data exchanged via a cookie, and the like. The central server 102 can verify the user identification and in one embodiment, relates the user with a subscription account. The process advances from the third block 330 to a fourth block 340.

In the fourth block 340, the process retrieves and displays a list of available peer computers selected from a list of associated computers or a peer list. The peer list can be stored in the user computer, in the central server 102, or in another computer. The peer list can be modified by adding and deleting users or user computers to and from the list. User computers in the peer list can be identified by usemame, machine addresses, machine names, and the like. It will be understood by one of ordinary skill in the art that in some cases, a machine address such as an IP address can be dynamic and should be tracked by the central server 102. The process advances from the fourth block 340 to a fifth block 350.

In the fifth block 350, the process permits a user to select a peer computer from the peer list. In one embodiment, a peer computer from the peer list may advantageously not be made available unless both the user computer and the peer computer may be associated on each other's respective peer lists. The process advances from the fifth block 350 to a sixth block 360.

In the sixth block 360, the process establishes a peer-to-peer connection or communication path between the user computer and the selected peer computer. The connection can be via a connection-oriented protocol or more preferably, through a connectionless protocol. In one embodiment, the central server 102 obtains the machine address or the IP address of a computer as the computer accesses the central server 102, and the central server 102 provides the machine address to the user computer and/or to the peer computer to enable the user computer and the peer computer to establish a peer-to-peer connection. As described earlier, this connection can correspond to connection oriented protocols and connectionless protocols. The process advances from the sixth block 360 to a seventh block 370.

In the seventh block 370, the process retrieves a list of media clips that may advantageously be available for streaming. The media clips can correspond to a variety of formats, including compressed and uncompressed formats. One example of a streaming format for video may advantageously be RealVideo® format, Moving Pictures Experts Group (MPEG) format, Advanced Streaming Format (ASF), Audio Video Interleave (AVI) format, QuickTime (MOV) format, and others formats now in existence or later developed. One example of a streaming format for audio may be the RealAudio® format from RealNetworks, Inc. An example of an uncompressed audio format may be a WAV format. Examples of compressed audio formats include an MPEG, audio layer 3 (MP3) format, a Windows Media audio (WMA) format, an Advanced Audio Coding (AAC) format, and other formats now in existence or later developed.

In one embodiment, a user computer retrieves the list directly from the peer computer. In another embodiment, the list of media clips may advantageously be exchanged through the central server 102, which can also be configured to store the list of media clips. One embodiment of the process further arranges the list of media clips into media clips that may advantageously be freely available to a peer and to media clips that require an additional authorization step, such as authorization through a password or through a pop-up window. For example, where a media clip requires an additional authorization step, the title of the media clip can be emphasized by shading and the like. The process advances from the seventh block 370 to an eighth block 380.

In the eighth block 380, the process permits a user to select a media clip from the list of media clips. The process advances from the eighth block 380 to ninth block 390.

In the ninth block 390, the process streams the selected media clip from the peer computer to the user computer. In one embodiment, the selected media clip may advantageously be provided only in a streaming format in approximately real time, and the media clip may not be provided as a download of a file. It will be understood by one of ordinary skill in the art that even in a streaming format, a portion of a streamed media clip can be temporarily stored in a data buffer without a download of the corresponding file. Preferably, the media clip may advantageously be streamed in accordance with a connectionless protocol such as UDP, IPX, or RTSP, as discussed above. One embodiment of the process permits users within the peer group to simultaneously chat while a media clip may be streamed. This permits users to discuss a media clip while the media clip may be played. Another embodiment of the process permits the simultaneous streaming of a media clip to multiple users within the peer group. In one embodiment, the streaming of a media clip may advantageously be sent to a peer group or subset of a peer group by a member of the peer group that initiates streaming to the peer group of the subset. In one embodiment, when the initiator of the streaming to a peer group decouples from the streamed media clip by hanging up, powering off, logging off, signing off, disconnecting from a network, and the like, the streaming of the media clip to the entire peer group or subset thereof may advantageously be disabled.

In one embodiment, a user controls the streaming of the media clip on both the user's computer and the peer computer that contains the media clip and can, for example, control pausing of the media clip. In one example, a user on the user's work computer streams a media clip from the user's home computer to the user's work computer.

IV. Selecting Multiple Media Clips

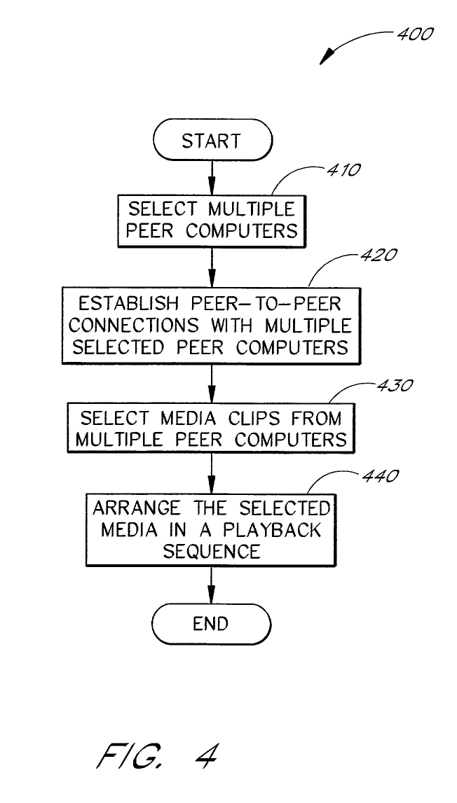

FIG. 4 illustrates a process 400 according to an embodiment of the invention of selecting multiple media clips from multiple peer computers for streaming. Advantageously, the process 400 permits a user or a group of users to receive streamed media clips from a variety of peer computers, thereby increasing the amount of media content that may be available to be automatically streamed in a sequence. It will be understood that the process can be varied in a number of ways, including variations in the sequence or order in which the various blocks have been presented.

In a first block 410, the process permits a user to select multiple peer computers from the active peer computers. In one embodiment, after the user signs in or logs into the central server 102, the central server 102 informs the user which computers in an associated group of peer computers may advantageously be similarly signed in or logged into the central server 102. The central server 102 can communicate the peer group information with the user's computer automatically or in response to a query from the user's computer. The process advances from the first block 410 to a second block 420.

In the second block 420, the process permits the user to establish peer-to-peer network connections with at least some of the peer computers in the associated group of peer computers. For example, the process can allow connection with a peer computer that may be available. The connection can be via a connectionless protocol or a connection-oriented protocol. In one embodiment, the central server 102 provides connection information, such as IP addresses, for the peer computers as described earlier in connection with FIG. 3. The process advances from the second block 420 to a third block 430.

In the third block 430, the process permits a user to select media clips from multiple computers. In one embodiment, the process displays available media clips from multiple computers in the media clip browse window 204 described earlier in connection with FIG. 2. In one embodiment, the media clips can be selected from the media clips of associated peer computers that may advantageously be in communication with the user's computer in the peer-to-peer network. In another embodiment, the media clips that can be selected include media clips from peer computers that may not be connected in or communicating with the peer-to-peer network at the time of the selection of the media clips. The selected media clips can further include media clips that may advantageously be locally accessible from the user's computer. The process advances from the third block 430 to a fourth block 440.

In the fourth block 440, the process permits the user to arrange the selected media clips in a playback sequence. A playback sequence can correspond to an arrangement of media clips. The playback sequence does not have to include the content of the media clips. For example, the playback sequence can correspond to a list of media clips. The media clips can be locally stored or retrieved from remote resources. For example, media clips corresponding to music can be arranged to play in a jukebox manner. The arrangement of selected media can be used immediately or can be saved for later use or modification.

V. Streaming Multiple Media Clips

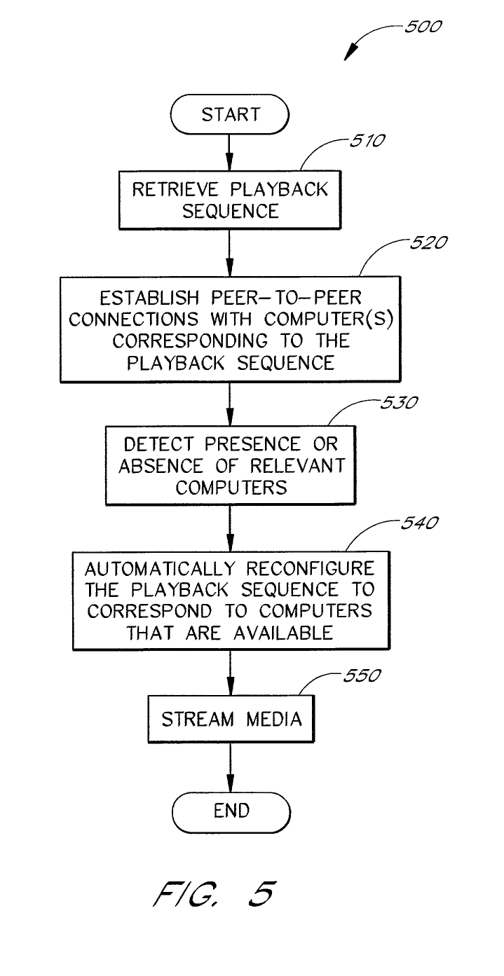

FIG. 5 illustrates a process 500, according to an embodiment of the invention, of streaming multiple media clips from multiple peer computers. The process advantageously compensates for the peer computers that drop out of the group or connect to the group after streaming has initiated.

The process starts at a first block 510, where a playback sequence may be retrieved or may be generated. The playback sequence can be generated as described in connection with FIG. 4, or can be retrieved from a file, such as a file that may be locally stored or a file that may be received from a remote computer. The playback sequence can include media clips of the same type, such as audio-only media clips, or can include media clips of various types, such as a mix of audio and video media clips. The process advances from the first block 510 to a second block 520.

In the second block 520, the process establishes a peer-to-peer network connection with the appropriate peer computers in the peer group so that the user computer can receive a stream of the media clip indicated in the playback sequence. It will be understood that the protocols used in the peer-to-peer network can correspond to a broad variety of protocols, including connectionless protocols, some of which do not require that a channel be established between communicating computers. In addition, where connections have already been established, such as from a previous session, it will be understood that those connections do not have to be re-established. The process advances from the second block 520 to a third block 530.

In the third block 530, the process detects whether peer computers indicated in the playback sequence may be present or absent in the peer-to-peer network. In one embodiment, the process communicates with the central server 102 to obtain the connection status of a desired peer computer. The connection status can be automatically sent by the central server 102 on a periodic basis or can be sent by the central server 102 in response to a query from a user's computer. The process advances from the third block 530 to a fourth block 540.

In the fourth block 540, the process reconfigures the playback sequence to compensate for peer computers that may not be available for streaming of media clips. For example, where a playback sequence includes 10 songs from 3 different peer computers and one of the peer computers disconnects or otherwise decouples from a network such as the networked system 100 illustrated in FIG. 1A, the process can skip the playback of media clips from the disconnected peer computer to allow the remainder of the playback sequence to play. Similarly, when a peer computer becomes available, the process can add the media clips that were skipped in the playback sequence to allow the playback sequence to resume the streaming of media clips as originally intended. The process advances from the fourth block 540 to a fifth block 550.

In the fifth block, the process streams the selected media clips to the user's computer. The process advantageously streams the media clips rather than downloads the media clips, which substantially discourages the unauthorized duplication of content and permits the playing of the media clip to initiate before an entire file may be received. Playing of the media clip can include the reproduction of recorded sounds, recorded visual content, and combinations of both.

VI. Media Clip Arrangement Data Structure

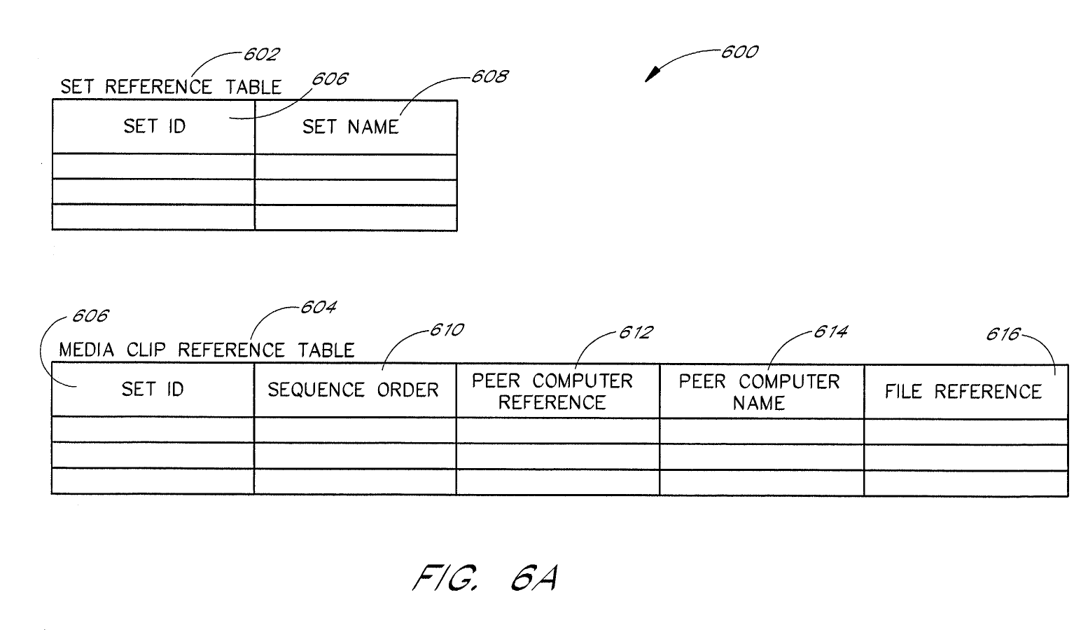

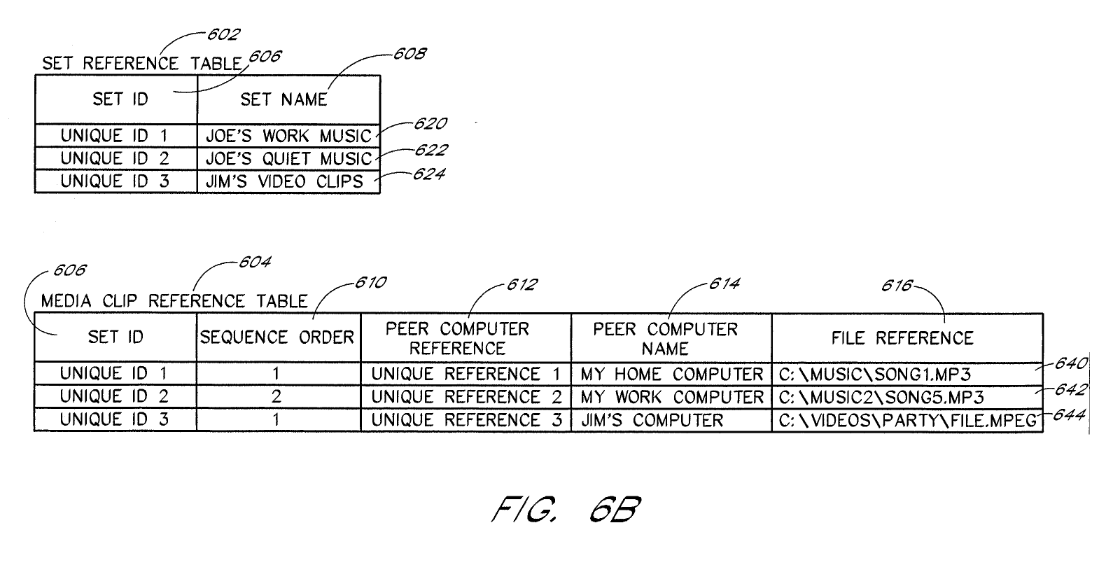

FIG. 6A illustrates a data structure 600 that can be used by a system to store or to maintain arrangements of media clips. The exemplary data structure 600 permits users to store multiple arrangements of media clips so that a particular arrangement may be easily retrieved for easy and efficient playback of the media clips identified therein. The exemplary data structure 600 also permits a user to share an arrangement of media clips with another user without actually sharing the content of the media clips. Though the illustrated data structure 600 shown has the form of a relational database, one of ordinary skill in the art will recognize that the database may also be, by way of example, an object oriented database, a hierarchical database, a lightweight directory access protocol (LDAP) directory, an object oriented-relational database, and other data structures. The database may conform to any database standard, or may even conform to a non-standard, private specification. In one embodiment, the system uses a database that complies with a SQL ANSI 92 standard. The database can also be implemented utilizing any number of commercially available database products such as, by way of example, Oracle® from Oracle Corporation, SQL Server and Access from Microsoft Corporation, Sybase® from Sybase, Incorporated, and other databases.

The data structure 600 shown utilizes a relational database management system (RDBMS). In a RDBMS, the data may advantageously be stored in the form of tables. Conceptually, the data within the table may be stored within fields that may advantageously be arranged into columns and rows. Each field contains one item of information. Each column within a table may advantageously be identified by its column name and contains one type of information, such as the name of a process. A record, also known as a tuple, contains a collection of fields constituting a complete set of information. In one embodiment, the ordering of rows does not matter as the desired row can be identified by examination of the contents of the fields in at least one of the columns or by a combination of fields.

By way of example, the data structure 600 uses two tables. These tables correspond to a Set Reference Table 602 and a Media Clip Reference Table 604. The data structure 600 illustrates a convenient way to maintain data such that an embodiment using the data structure 600 can store and retrieve the data therein.

The illustrated Set Reference Table 602 contains two fields. These fields correspond to a Set ID field 606 and a Set Name field 608. The Set ID field 606 can contain a unique identifier to identify a record in the Set Reference Table 602. As will be understood by one of ordinary skill in the art, each valid record in a relational database table should be identifiable by a unique entry in a field or combination of fields. The Set Name field 608 can contain the name of a set of media clips. For example, a user can store a sequence or arrangement of media clips under easy to remember names, such as JOE'S WORK MUSIC, or JOE'S QUIET MUSIC. It will be understood by one of ordinary skill in the art that in another embodiment, the data structure uses unique entries in the Set Name field 608 and does not need the Set ID field 606. Additional fields can be used to store genres, estimated durations, ratings, usemames, and the like.

The illustrated Media Clip Reference Table 604 stores information related to locating a media clip in a set or arrangement of media clips. The Media Clip Reference Table 604 includes the Set ID field 606, a Sequence Order field 610, a Peer Computer Reference field 612, a Peer Computer Name field 614, and a File Reference field 616. The Set ID field 606 relates a record in the Media Clip Reference Table 604 to a particular set or arrangement. For example, where a particular arrangement or set contains 5 songs, each song can correspond to a record in the Media Clip Reference Table 604, and each song has the same identifier stored in the Set ID field 606 to relate the 5 songs to the corresponding set. The Sequence Order field 610 can contain a reference relating to the sequence in which the corresponding media clip plays in the particular set or arrangement identified in the Set ID field 606. In one embodiment, the Sequence Order field 610 arranges the music clips by a numerical order stored in the Sequence Order field 610. It will be understood by one of ordinary skill in the art that alphabetical characters can also be used to maintain a sequence.

The Peer Computer Reference field 612 contains a reference to the user or to the user computer in which the media clip may be stored. For example, the Peer Computer Reference field 612 can contain a username associated with the user and/or user computer by the central server 102, or can contain an IP address, and so forth. The computer identified can correspond to the user computer or to a peer computer. The Peer Computer Name field 614 can contain an alternative name for the user and/or user computer identified in the Peer Computer Reference field 612. For example, the alternative name stored in the Peer Computer Name field 614 can correspond to an easier to remember name. The File Reference field 616 can contain information such as a filename and path for the corresponding media clip on the user computer identified in the Peer Computer Reference field 612. The filename can correspond to a name of a file. It will be understood that file naming conventions can vary from operating system to operating system. For example, some operating systems permit a file to have more than one filename. A path can correspond to a directory or a folder in which a file or other resource may be stored. The path can include a network resource. A specification of a path for a resource can also vary from operating system to operating system. A path can start at, for example, a root directory. A path can also start at a name of a network resource, such as a reference to a remote computer. A path is also referred to as a pathname.

VII. Media Clip Arrangement Data Structure

FIG. 6B illustrates the data structure 600 described earlier in connection with FIG. 6A with sample data. It will be understood that the sample data provided in FIG. 6B merely illustrates how a system or a method according to an embodiment of the invention can use the data structure 600 to store or to maintain arrangements of media clips.

The Set Reference Table 602 may be shown with a first record 620, a second record 622, and a third record 624. It will be understood that number of records in the Set Reference Table 602 can correspond to a very broad range. Each record in the Set Reference Table 602 may advantageously be identified by a unique reference in the Set ID field 606. For example, the unique reference can correspond to a number, but it will be understood by one of ordinary skill in the art that the unique reference can include strings of characters and other symbols, as well. In FIG. 6B, the character strings UNIQUE ID 1, UNIQUE ID 2, and UNIQUE ID 3 uniquely identify the first record 620, the second record 622, and the third record 624, respectively. In one example, UNIQUE ID 1, UNIQUE ID 2, and UNIQUE ID 3 respectively correspond to 00001, 00002, and 00003.

A user can identify the first record 620, the second record 622, and the third record 624 with a name or a title, such as a description, stored in the Set Name field 608 of the corresponding record. In the example, the first record 620 stores the name JOE'S WORK MUSIC in the Set Name field 608. The contents of the Set Name field 608 can, for example, correspond to a title of the corresponding arrangement of media clips.

The Media Clip Reference Table 604 stores information related to locating a media clip in a set or arrangement of media clips. The Media Clip Reference Table 604 may be shown with a fourth record 640, a fifth record 642, and a sixth record 644. It will be understood that number of records in the Media Clip Reference Table 604 can correspond to a very broad range. The contents of the Set ID field 606 relate records in the Set Reference Table 602 to records in the Media Clip Reference Table 604. For example, the contents of the Set ID field 606 for both the fourth record 640 and the fifth record 642 correspond to UNIQUE ID 1. This relates the fourth record 640 and the fifth record 642 of the Media Clip Reference Table 604 to the first record 620 of the Set Reference Table 602. The sixth record of the Media Clip Reference Table 604, with a content of UNIQUE ID 3 stored in the Set ID field 606, may be related to the third record 624 of the Set Reference Table 602, also with a content of UNIQUE ID 3 stored in the Set ID field 606.

The values of 1 and 2 may be stored in the Sequence Order field 610 of the Media Clip Reference Table 604 for the fourth record 640 and for the fifth record 642, respectively. In this example, this informs the media clip player to select and to play the media clip corresponding to the fourth record 640 before selecting and playing the media clip corresponding to the fifth record 642.

In the example, the Peer Computer Reference field 612 stores a reference to the user or to the user computer in which the corresponding media clip may advantageously be stored. In one embodiment, the reference may advantageously be provided by a central server, which maintains unique references for peer computers. The reference can be cross-referenced by the central server to machine addresses including dynamically variable IP addresses. In the example, the unique references may advantageously be illustrated as UNIQUE REFERENCE 1, UNIQUE REFERENCE 2, and UNIQUE REFERENCE 3, respectively, for the fourth record 640, the fifth record 642, and the sixth record 644.

In the example, the Peer Computer Name field 614 stores a name, which can be determined by selected by the user maintaining the arrangement of media clips, for the corresponding user computer that stores the media clip. The names stored in the Peer Computer Name field 614 can be easier to remember than a machine address, such as an IP address. The name can be a nickname or a relatively easy to remember string, such as MY HOME COMPUTER, MY WORK COMPUTER, and JIM'S COMPUTER, which may advantageously be stored in the Peer Computer Name field 614 of the fourth record 640, the fifth record 642, and the sixth record 644, respectively.

The File Reference field 616 stores a path and a filename for a media clip corresponding to a record in the Media Clip Reference Table 604. It will be understood by one of ordinary skill in the art that a particular media clip can appear in the Media Clip Reference Table 604 multiple times. The contents of the File Reference field 616 relate a file in a user computer to a record in the File Reference field 616. In the example, the contents of the File Reference field 616 for the fourth record 640, the fifth record 642, and the sixth record 644 may correspond to C:\MUSIC\SONG1.MP3, C:\MUSIC2\SONG5.MP3, and C:\VIDEOS\PARTY\FILE.MPG, respectively.

To illustrate the use of the exemplary data structure 600, a user selects a media arrangement corresponding to JOE'S WORK MUSIC by selecting the first record 620 of the Set Reference Table 602. The database relates the UNIQUE ID 1 reference stored in the Set ID field 606 of the Set Reference Table 602 to records in the Media Clip Reference Table 604 that correspond to the first record 620. These records contain the same UNIQUE ID 1 reference in the SET ID field 606. The fourth record 640 and the fifth record 642 correspond to the records in the example shown in FIG. 6B. The playback order of the media clip sequence may advantageously be determined by arranging playback in the sequence indicated by the contents of the Sequence Order field 610. In one embodiment, a media clip corresponding to a record with a lower value in the Sequence Order field 610 may advantageously be played earlier than a media clip corresponding to a record with a higher value in the Sequence Order field 610 such that the media clip corresponding to the fourth record 640 may advantageously be played back earlier than the media clip corresponding to the fifth record 642.

The user computer forms a peer-to-peer network connection (as necessary) with the peer computers indicated in the Peer Computer Reference field 612 of the fourth record 640 and the fifth record 642 to receive a stream of the media clip. It will be understood that some of the media clips in an arrangement can be locally stored in the user computer, and may not be received as a stream from a peer computer.

VIII. Sample Operation

For illustrative purposes, a sample operation of a system and/or a method according to one embodiment of the invention may be described as follows. It will be understood that the sample operation described herein illustrates only one of many possible implementations of a system and/or a method according to an embodiment of the invention.

Company offers to users a download of a Web browser plug-in that configures a Web browser in a user computer to share a media clip with other user computers. The plug-in can be offered in conjunction with subscription packages that provide the user with a variety of different features. For example, Feature A can correspond to no advertisements. Feature B can correspond to permitting a user to have an unlimited number of users in a peer group. Feature C can correspond to providing a chat function. Feature D can correspond to music sharing. In one example, Company offers three subscription plans with names Gold, Silver, and Bronze, as described in Table I.

TABLE I

| | |
|---|---|
| Gold | Features A, B, C, and D |
| | Cost: $20.00 per month |
| Silver | Features B, C, and D |
| | Cost: $10.00 per month |
| Bronze | Feature D |
| | Cost: free |

Users can subscribe to a plan, download the applicable plug-in, and share media clips. For example, Brian, a user, can sign up with Company for one of the subscription plans and download an appropriate plug-in. The plug-in can be provided by Company as a download over a network in response to receiving an election of a subscription plan, a subscription term, customer information, such as a name, email address, credit card information, and the like, from user Brian. In one arrangement, the Company can provide a trial period, such as 5 days, for a feature that may advantageously be included in a more premium subscription plan than the plan that was selected by user Brian. A cookie can be sent from Company to Brian's computer that enables the more premium feature for the trial period.

With the use of the plug-in, Brian can sign in to a central server. Using data received from the central server, Brian can select other users to form a peer group. In one example, Brian may be added to an existing peer group by another user. The central server provides Brian's computer with machine addresses of peer computers within the peer group such that a peer-to-peer network can be formed between Brian's computer and a peer computer. Brian browses through titles of various media clips to select a media clip for streaming. Brian can also select and arrange multiple media clips for streaming.

In response to the selection of a media clip, a peer computer streams the selected media clip to Brian's computer via the peer-to-peer network.

Various embodiments of the invention have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

I claim:

1. A media clip sharing system comprising:
a central server adapted to communicate with a plurality of user computers in a network, the central server being adapted to identify a first user through a sign-in process and at least temporarily storing a relationship between the first user and a first machine address in a memory, the central server being configured to provide the first machine address associated with the first user to a user computer operated by a second user, the first user and the second user being associated in a peer list;
a first user computer corresponding to the first machine address, where the first user computer is coupled with the central server and is configured to communicate with the central server as a client, the first user computer maintaining a media clip in local memory and being configured to send a stream of the media clip to another user computer; and
a second user computer coupled with the central server and configured to communicate with the central server as a client, the second user computer being configured to receive the first machine address from the central server such that the second user computer can communicate with the first user computer in a peer-to-peer network, and the second user computer being configured to receive and to play the stream of the media clip from the first user computer.

2. The media clip sharing system of claim 1, where the first user and the second user are the same user.

3. The media clip sharing system of claim 1, where the second user computer is further configured to receive indications of media clips that are available in the first user computer and to allow selection of the media clip that is to be streamed.

4. The media clip sharing system of claim 1, where the machine address is an Internet Protocol (IP) address.

5. The media clip sharing system of claim 1, wherein the first user computer and the second user computer are configured to communicate with each other with a connectionless protocol.

6. A method of receiving a media clip over a network by a first node comprising:
coupling the first node with the network;
communicating with a central node coupled with the computer network;
receiving an indication from the central node that a second node is coupled with the central node;
receiving a machine address of the second node;
using the machine address to communicate with the second node in a peer-to-peer architecture; and
receiving a stream of a media clip from the second node.

7. The method of claim 6, further comprising:
receiving an indication from the central node of a status of users in a peer list, where the status indicates whether a node associated with a user in the peer list is also in communication with the central node; and
selecting a node from the peer list as the second node.

8. The method of claim 6, where the receiving of the machine address of the second node occurs only when the first node and the second node are associated in a peer group.

9. The method of claim 6, further comprising providing a chat function from the first node to the second node at least while the media clip is streamed.

10. The method of claim 6, further comprising:
controlling the streaming at the first node; and
playing the media clip that is streaming at the first node and at the second node at substantially the same time.

11. The method of claim 10, wherein the controlling the streaming comprises at least one of initiating, terminating, pausing, skipping, rewinding, reversing, and fast forwarding of the streaming.

12. The method of claim 6, further comprising:
receiving a plurality of indications of media clips that are available to be streamed; and
selecting the media clip from the plurality of indications of media clips.

13. The method of claim 6, further comprising:
communicating with a plurality of nodes that are in communication with the central node;
receiving a plurality of indications of media clips that are available to be streamed; and
selecting the media clip from the plurality of indications of media clips.

14. The method of claim 6, further comprising streaming the media clip in a predetermined sequence with a plurality of media clips, where the plurality of media clips are stored in at least two different nodes that are coupled with the first node.

15. The method of claim 6, further comprising receiving the stream of the media clip from the second node to the first node only when the first node and the second node are in a peer group.

16. The method of claim 6, further comprising:
prompting the second node for authorization prior to receiving the stream of the media clip from the second node to the first node; and
receiving the stream the media clip in response to authorization from the second node.

17. A method of arranging a plurality of media clips in a playback sequence, the method comprising:
coupling with a first computer;
retrieving a first path and a first filename corresponding to a first media clip that is stored on the first computer;
adding the first path and first filename to the playback sequence;
coupling with a second computer;
retrieving a second path and a second filename corresponding to a second media clip that is stored on the second computer;
adding the second path and the second filename to the playback sequence; and
using the playback sequence to automatically initiate streaming of the first media clip from the first computer and the second media clip from the second computer.

18. The method of claim 17, where the first computer and the second computer area associated in a peer group, and further comprising confining the streaming of the first media clip and the second media clip to a user computer that is also associated in the peer group.

19. The method of claim 17, further comprising automatically detecting an absence of the first computer and automatically reconfiguring the playback sequence to exclude media clips that correspond to the first computer.

20. The method of claim 17, further comprising:
forming peer-to-peer communication paths with the first computer and with the second computer; and
receiving the first media clip and the second media clip via the peer-to-peer communication paths.

21. A method of sharing media over a network comprising:
coupling a first user computer and a second user computer in a peer-to-peer architecture;
allowing a user to select a media clip from the first user computer;
streaming a media clip from the first user computer to the second user computer; and
playing back the media clip while the media clip is streamed from the first user computer to the second user computer, the playing back occurring on both the first user computer and on the second user computer at substantially the same time.

22. The method of claim 21, further comprising providing a chat function between the first user computer and the second user computer while the media clip is played.

23. A method performed by a first node of sending a media clip over a network, the method comprising:
establishing a connection to a computer network with the first node;
communicating with a central node, where the central node is coupled with the computer network;
receiving a request from a second node for the media clip, said media clip being locally available to the first node;
receiving a machine address of the second node;
using the machine address to communicate with the second node in a peer-to-peer architecture; and
sending a stream of the requested media clip from the first node to the second node.

24. The method of claim 23, further comprising displaying the requested media clip on the first node as the requested media clip is sent to the second node.

25. The method of claim 23, further comprising providing the second node with a list of media clips that are available to be streamed.

26. The method of claim 23, further comprising:
determining whether the second node and the first node are in a peer group; and
communicating with the second node only when the second node and the first node are in the peer group.

27. A computer readable medium comprising:
a first module adapted to configure a first node to establish a connection to a computer network;
a second module adapted to communicate with a central node over the computer network and to receive an indication from the central node of a peer node coupled with the central node;
a third module adapted to receive a machine address of the peer node;
a fourth module adapted to use the machine address to communicate with the peer node; and
a fifth module adapted to communicate with the peer node to initiate a stream of a media clip from the peer node.

28. The computer readable medium of claim 27, further comprising a sixth module configured to enable at least one of the first module, the second module, the third module, the fourth module, and the fifth module to plug in to a browser.

29. The computer readable medium of claim 27, further comprising a sixth module adapted to receive the media clip from the peer computer when the media clip is streamed from the peer node.
